(19) United States
(12) Patent Application Publication
(10) Pub. No.: US 2026/0227992 A1
(43) Pub. Date: Aug. 6, 2026

(54) SOFTWARE UPDATE SYSTEM, SOFTWARE UPDATE DEVICE, SOFTWARE UPDATE METHOD, AND STORAGE MEDIUM

(71) Applicant: HONDA MOTOR CO., LTD., TOKYO (JP)

(72) Inventors: Yutaro YASUDA, TOKYO (JP); Yasumasa KAITANI, TOKYO (JP); Yujiro KOMIYAMA, TOKYO (JP)

(21) Appl. No.: 19/456,430

(22) Filed: Jan. 22, 2026

(30) Foreign Application Priority Data
Jan. 27, 2025 (JP) 2025-011067

(51) Int. Cl. G06F 8/65; H04L 67/12

(52) U.S. Cl. CPC G06F 8/65; H04L 67/12

(57) ABSTRACT

If a confirmation process is not completed within a predetermined time, an update processing unit provided in a software update system does not execute a software update process but executes a shutdown after causing a display control unit to execute the display of a shutdown notification screen, and if a response from the display control unit to a request for the display of the shutdown notification screen is not acquired, the update processing unit executes the shutdown after repeating retries a predetermined number of times.

### CROSS-REFERENCE TO RELATED APPLICATIONS

This application is based upon and claims the benefit of priority from Japanese Patent Application No. 2025-011067 filed on January 27, 2025, the contents of which are incorporated herein by reference.

### BACKGROUND OF THE INVENTION

### Field of Invention

The present disclosure relates to a software update system, a software update device, a software update method, and a storage medium.

### Description of the Related Art

JP 2011-040912 A discloses a vehicle-mounted network device for rewriting a rewritable program of a computing device connected to a network.

### SUMMARY OF THE INVENTION

It is desirable to update software in a favorable manner.

The present disclosure aims to solve the aforementioned problems.

A first aspect of the present disclosure is a software update system including a vehicle, a server device configured to communicate with the vehicle via a network, a permission confirmation unit configured to execute a confirmation process to confirm with a user whether to permit execution of a software update process for an electronic control unit provided in the vehicle, and an update processing unit configured to execute the software update process in a case where the execution of the software update process is permitted by the user, wherein in a case where the confirmation process is not completed within a predetermined time, the update processing unit does not execute the software update process and executes a shutdown after causing a display control unit to execute the display of a shutdown notification screen, and in a case where a response from the display control unit to a request for the display of the shutdown notification screen is not acquired, the update processing unit executes the shutdown after repeating retries a predetermined number of times.

A second aspect of the present disclosure is a software update system including a vehicle, a server device configured to communicate with the vehicle via a network, a permission confirmation unit configured to execute a confirmation process to confirm with a user whether to permit execution of a software update process for an electronic control unit provided in the vehicle, and an update processing unit configured to execute the software update process in a case where the execution of the software update process is permitted by the user, wherein in a case where the confirmation process is not completed within a predetermined time, the update processing unit does not execute the software update process and executes a shutdown without causing a display control unit to execute display of a shutdown notification screen.

A third aspect of the present disclosure is a software update device in the software update system according to the first or second aspect, wherein the software update device includes the permission confirmation unit and the update processing unit.

A fourth aspect of the present disclosure is a software update method in which date communication is performed between a vehicle and a server device via a network, a permission confirmation step of executing a confirmation process to confirm with a user whether to permit execution of a software update process for an electronic control unit provided in the vehicle, and an update processing step of executing the software update process in a case where the execution of the software update process is permitted by the user, wherein in a case where the confirmation process is not completed within a predetermined time, in the update processing step, the software update process is not executed and a shutdown is executed after a display control unit is caused to execute the display of a shutdown notification screen, and in a case where a response from the display control unit to a request for the display of the shutdown notification screen is not acquired, in the update processing step, the shutdown is executed after retries are repeated a predetermined number of times.

A fifth aspect of the present disclosure is a program that causes a computer to execute the software updating method according to the fourth aspect.

According to the present disclosure, software update can be performed favorably.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic diagram showing a software update system;

FIG. 2 is a flowchart of a software update process performed in the software update system;

FIG. 3 is a flow chart of the first process performed by a software update device during a period from IG-OFF to IG-ON (READY);

FIG. 4 is a time chart showing a state of each of a switch, an IVI, a software update device, a timer, and an MID; and

FIG. 5 is a flow chart of a second process performed by the software update device during a period from IG-OFF to IG-ON (READY).

### DETAILED DESCRIPTION OF THE INVENTION

Conventionally, software update for a vehicle-mounted electronic control unit (ECU) was performed at a dealer or the like. Recently, vehicles capable of updating ECU software via OTA (over the air) using wireless communication have been commercially available. Such vehicles can update ECU software without being brought to a dealer or the like.

For example, a vehicle is equipped with a software update device and a display device that perform a software update process. A software update device causes a display device to display a screen related to the software update process during the software update process. However, when the display device and the software update device become out of synchronization, the display device becomes unresponsive to a request for displaying a screen sent from the software update device. Then, the software update device repeats the retry of the display request. The software update device cannot be shut down if it repeats a retry until it acquires a response from the display device immediately before the shutdown. In this case, electric power continues to be supplied to the devices that are cut off from power supply with the shutdown of the software update device. Therefore, the remaining capacity of the battery equipped in the vehicles significantly reduces. In contrast, according to the present disclosure described below, it is possible to suppress the decrease in the remaining capacity of the battery equipped in the vehicle.

### 1 Configuration of Software Update System 10

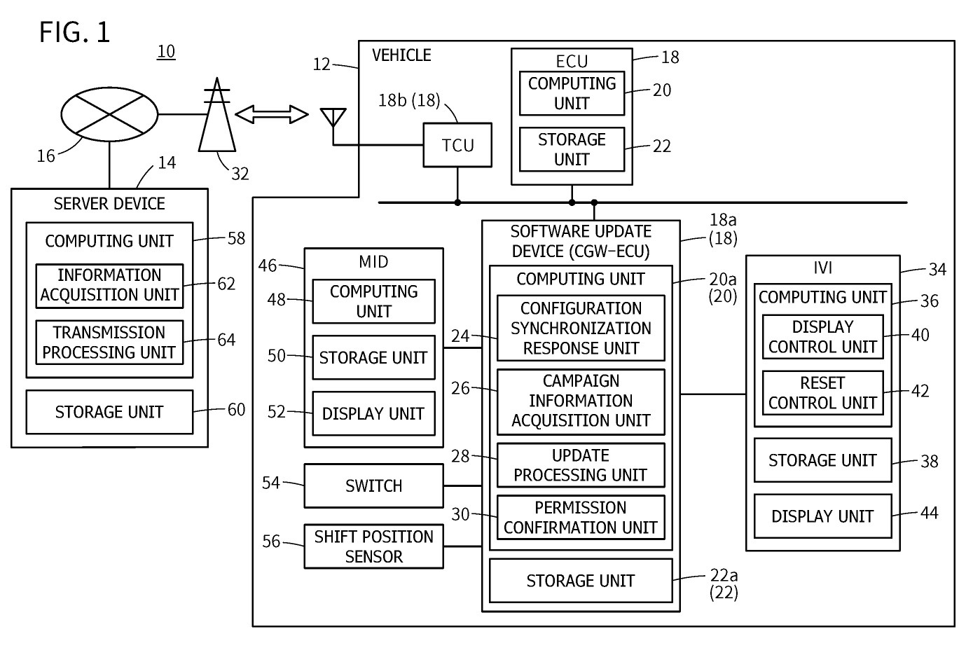

FIG. 1 is a schematic diagram showing a software update system 10 according to one embodiment. The software update system 10 includes a vehicle 12 and a server device 14. The server device 14 is capable of communicating with the vehicle 12 via a network 16.

A plurality of ECUs 18 are mounted in the vehicle 12. Each ECU 18 performs control to implement a traveling function and other functions of the vehicle 12. Each ECU 18 has a computing unit 20 and a storage unit 22. The computing unit 20 is a processor such as a CPU (Central Processing Unit), a GPU (Graphics Processing Unit), or the like. At least part of the computing unit 20 may be realized by an integrated circuit such as an ASIC (Application Specific Integrated Circuit), an FPGA (Field-Programmable Gate Array), or the like. At least part of the computing unit 20 may be realized by an electronic circuit including discrete devices.

The storage unit 22 is a computer-readable, non-transitory tangible storage medium. The storage unit 22 is composed of a volatile memory (not shown) and a nonvolatile memory (not shown). The volatile memory is, for example, RAM (Random Access Memory) or the like. The nonvolatile memory is, for example, ROM (Read Only Memory), flash memory, or the like. Data or the like are stored, for example, in the volatile memory. Programs, tables, maps, or the like are stored, for example, in the non-volatile memory. At least part of the storage unit 22 may be provided in the above-mentioned processor, integrated circuit, or the like. At least part of the storage unit 22 may be mounted in a device connected to the vehicle 12 via the network 16.

Each ECU 18 is connected to the CAN (Controller Area Network) (registered trademark in Japan). Each ECU 18 can communicate with each other through the CAN. The communication line to which each ECU 18 is connected is not limited to the CAN, and the Ethernet (registered trademark in Japan) may be used, or both CAN and Ethernet may be used. Furthermore, as the communication line, a communication line according to other standards than the CAN and the Ethernet may be used.

The ECUs 18 may include a software update device 18a and a telematics control unit (TCU) 18b.

The software update device 18a can be constituted by, for example, a CGW-ECU (Central GateWay-Electronic Control Unit). The software update device 18a has a computing unit 20a and a storage unit 22a. The computing unit 20a includes a configuration synchronization response unit 24, a campaign information acquisition unit 26, an update processing unit 28, and a permission confirmation unit 30. The configuration synchronization response unit 24, the campaign information acquisition unit 26, the update processing unit 28, and the permission confirmation unit 30 are realized by the computing unit 20a executing programs stored in the storage unit 22a. At least part of the configuration synchronization response unit 24, the campaign information acquisition unit 26, the update processing unit 28, and the permission confirmation unit 30 may be realized by an integrated circuit such as an ASIC or an FPGA. At least part of the configuration synchronization response unit 24, the campaign information acquisition unit 26, the update processing unit 28, and the permission confirmation unit 30 may be realized by an electronic circuit including discrete devices.

The software update device 18a performs the software update process for the ECU 18 (including the software update device 18a). The software update process includes a software download process, a software installation process, a software activation process, and a completion process.

The software downloading process includes a process of acquiring the update data transmitted from the server device 14 via the network 16 and storing the data in the storage unit 22a of the software update device 18a. The update data is data including a program or the like of the updated software. The update data may include an installer or the like.

The software installation process includes a process of loading the update data of the storage unit 22a into the ROM of the ECU 18. The software installation process may be performed by an installer. The software installation process may be performed by copying the update data to the ROM.

The software activation process includes a process of authenticating the license of the installed software. Executable files and so on used by the prior-to-updating software may be rewritten during the software activation process. When the software activation process is completed, the software is allowed to be executed at the ECU 18. The activation process may be performed by the software update device 18a or by another ECU 18.

The completion process involves post-processing of the software update. For example, the complete process includes a process of uploading a result log to the server device 14 and a process of notifying the user that the software update has been completed. The result log includes information on whether the software of the ECU 18 has been successfully updated, information on the time when the activation process has been completed, and the like.

The configuration synchronization response unit 24 transmits configuration synchronization information to the server device 14 in response to a configuration synchronization request transmitted from the server device 14. The campaign information acquisition unit 26 acquires campaign information, which is information related to the software update process, from the server device 14 and stores the campaign information in the storage unit 22a. The update processing unit 28 executes the software update process for the ECU 18 that includes the software to be updated. The permission confirmation unit 30 performs a confirmation process of confirming with the user whether to permit the ECU 18 to execute the software update process.

The software update device 18a is capable of communicating, via the TCU 18b, with the base station 32 connected to the network 16 through cellular communication. The network 16 is, for example, the Internet.

An in-vehicle infotainment system (hereinafter, “IVI”) 34 is connected to the software update device 18a. The IVI 34 includes a computing unit 36 and a storage unit 38. The computing unit 36 is, for example, a processor such as a CPU or a GPU. The computing unit 36 includes a display control unit 40 and a reset control unit 42. The display control unit 40 and the reset control unit 42 are realized by the computing unit 36 executing programs stored in the storage unit 38. The display control unit 40 and the reset control unit 42 may be realized by integrated circuits such as an ASIC or an FPGA. The display control unit 40 and the reset control unit 42 may be realized by electronic circuits including discrete devices.

The display control unit 40 performs display control of various screens. The reset control unit 42 executes reset control to restore the IVI 34 to the initial state, which is a state at the time of shipment from the factory, when a failure occurs in the processes performed by the computing unit 36.

The storage unit 38 is a computer-readable, non-transitory tangible storage medium. The storage unit 38 is composed of a volatile memory (not shown) and a nonvolatile memory (not shown). The volatile memory is, for example, RAM or the like. The non-volatile memory is, for example, ROM, flash memory, or the like. Data or the like are stored, for example, in the volatile memory. Programs, tables, maps, or the like are stored, for example, in the non-volatile memory. At least part of the storage unit 38 may be provided in the above-mentioned processor, integrated circuit, or the like. At least part of the storage unit 38 may be mounted in a device connected to the vehicle 12 via the network 16.

The IVI 34 provides information such as display of road traffic information and route guidance and also provides entertainment through audio, DVD, TV tuner, and so on. The IVI 34 is constituted by, for example, display audio.

The IVI 34 includes the display unit 44. The display unit 44 is installed on a dashboard or the like of the vehicle 12. The display unit 44 is a touch panel display. The display unit 44 provides the user with information in the form of images, characters, and so on and accepts operation input performed by the user. The screen of the display unit 44 may be a liquid crystal display, an organic electroluminescence (organic EL) display, or the like, but is not particularly limited to this type of display. The touch panel of the display unit 44 is not particularly limited and may be a resistive film type, a capacitance type, or the like. Instead of the display unit 44 that is a touch panel display, a combination of a display device such as a head-up display and a pointing device such as motion capture may be used.

A multi-information display (hereinafter, “MID”) 46 is connected to the software update device 18a. The MID 46 includes a computing unit 48 and a storage unit 50. The computing unit 48 is, for example, a processor such as a CPU or a GPU.

The storage unit 50 is a computer-readable non-transitory tangible storage medium. The storage unit 50 is composed of a volatile memory (not shown) and a nonvolatile memory (not shown). The volatile memory is, for example, RAM or the like. The non-volatile memory is, for example, ROM, flash memory, or the like. Data or the like are stored, for example, in the volatile memory. Programs, tables, maps, or the like are stored, for example, in the non-volatile memory. At least part of the storage unit 50 may be provided in the above-mentioned processor, integrated circuit, or the like.

The MID 46 provides information related to the traveling of the vehicle 12, such as vehicle speed, engine speed, motor speed, distance traveled, remaining battery capacity, various warning lights, and the like. The MID 46 is constituted by, for example, a digital meter.

The MID 46 includes the display unit 52. The display unit 52 is installed on a dashboard or the like of the vehicle 12. The display unit 52 provides the user with information in the form of images, characters, and the like. The screen of the display unit 52 may be a liquid crystal display, an organic electroluminescence (organic EL) display, or the like, but is not particularly limited to this type of display.

The vehicle 12 is equipped with a start stop switch (hereinafter, “switch”) 54. The user operates the switch 54 to switch the power modes of the vehicle 12. When the vehicle 12 is an engine vehicle, the power modes include an OFF mode, an ACC mode, an ON mode, and a START mode. When the vehicle 12 is a hybrid vehicle or an electric vehicle, the power modes include an OFF mode, an ACC mode, and a READY mode.

The OFF mode is a state in which the power source of the vehicle 12 is OFF. In the OFF mode, most of the equipment of the vehicle 12 cannot be used. Even in the OFF mode, a keyless entry system and the like can be used. The state of the switch 54 in the OFF mode may be referred to as IG-OFF or ACC-OFF. In the ACC mode, devices such as an audio device can be used. The state of the switch 54 when in the ACC mode may be referred to as IG-OFF or ACC-ON. In the ON mode, all the equipment of the vehicle 12 can be used. The state of the switch 54 when in the ON mode may be referred to as IG-ON. The START mode is a state in which the engine starts, and the vehicle 12 is allowed to travel after the engine starts. The READY mode is a state in which the vehicle 12 can travel by means of the drive motor. The state of the switch 54 when in the READY mode may be referred to as READY.

The state of the switch 54 being IG-OFF corresponds to the state where a starting switch of the present invention is OFF. The state of the switch 54 being IG-ON (or READY) corresponds to the state where the starting switch of the present invention is ON.

The vehicle 12 is equipped with a shift position sensor 56. The shift position sensor 56 detects a shift position selected by the user's operation.

The server device 14 includes a computing unit 58 and a storage unit 60. The computing unit 58 is, for example, a processor such as a CPU or a GPU. The computing unit 58 includes an information acquisition unit 62 and a transmission processing unit 64. The information acquisition unit 62 and the transmission processing unit 64 are realized by the computing unit 58 executing programs stored in the storage unit 60. At least part of the information acquisition unit 62 and the transmission processing unit 64 may be realized by an integrated circuit such as an ASIC or an FPGA. At least part of the information acquisition unit 62 and the transmission processing unit 64 may be realized by an electronic circuit including discrete devices.

The storage unit 60 is a computer-readable non-transitory tangible storage medium. The storage unit 60 is composed of a volatile memory (not shown) and a nonvolatile memory (not shown). The volatile memory is, for example, RAM or the like. The non-volatile memory is, for example, ROM, flash memory, or the like. Data or the like are stored, for example, in the volatile memory. Programs, tables, maps, or the like are stored, for example, in the non-volatile memory. At least part of the storage unit 60 may be provided in the above-mentioned processor, integrated circuit, or the like. At least part of the storage unit 60 may be mounted in a device connected to the server device 14 via the network 16.

A plurality of the vehicles 12 are registered in the server device 14, and the server device 14 manages an updated state of the software of the ECUs 18 of each of the vehicles 12. The server device 14 provides each of the vehicles 12 with the update data for updating the software of the ECU 18 of each of the vehicles 12.

### 2 Software Update Process Performed by Software Update System 10

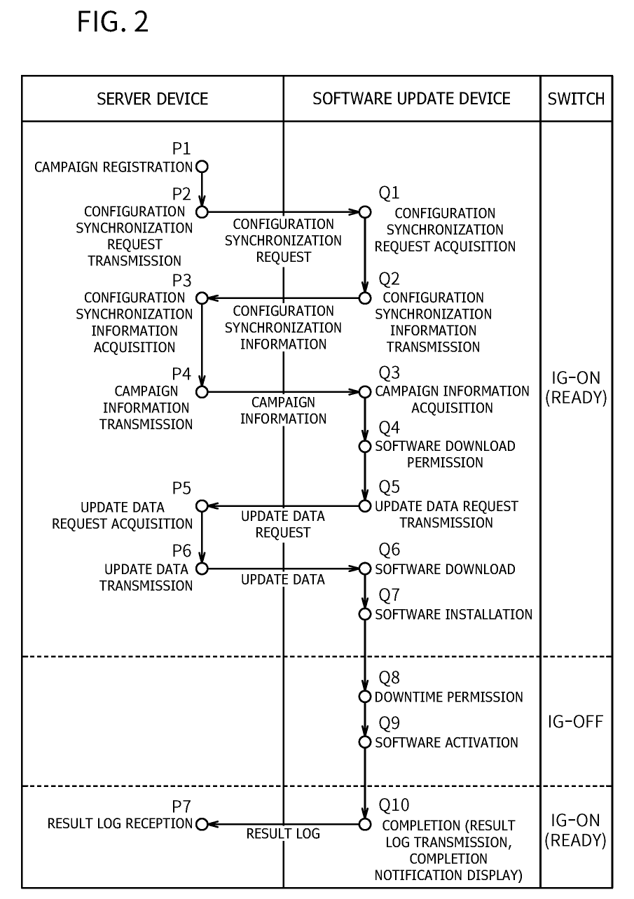

FIG. 2 is a flowchart of a software update process performed in the software update system 10. The software update process performed by the software update system 10 will be outlined with reference to FIG. 2.

When campaign information is registered in the server device 14 (P1), the transmission processing unit 64 transmits a configuration synchronization request to the software update device 18a of the vehicle 12 (P2). The campaign information, together with the update data for updating the software of the ECU 18, is registered in the server device 14 by a software developer of the ECU 18, a manufacturer of the vehicle 12, and so on.

The configuration synchronization response unit 24 of the software update device 18a transmits, upon acquiring the configuration synchronization request (Q1), the configuration synchronization information to the server device 14 (Q2). The configuration synchronization information includes information on a unique identifier assigned to each ECU 18 of the vehicle 12, information on a version of the software of each ECU 18, and the like.

When the information acquisition unit 62 of the server device 14 acquires the configuration synchronization information (P3), the transmission processing unit 64 transmits to the software update device 18a the campaign information on the software update process for each ECU 18 (P4).

The campaign information acquisition unit 26 of the software update device 18a acquires the campaign information (Q3) and stores the campaign information in the storage unit 22a. The update processing unit 28 causes the display unit 44 of the IVI 34 to display the campaign information. The confirmation process for confirming with the user whether to permit software download is performed by the permission confirmation unit 30. In this confirmation process, when the user permits the software download (Q4), the update processing unit 28 transmits an update data request to the server device 14 (Q5).

When the information acquisition unit 62 of the server device 14 acquires the update data request (P5), the transmission processing unit 64 transmits the update data to the software update device 18a (P6).

The update processing unit 28 of the software update device 18a executes a software download process. That is, the update processing unit 28 acquires the update data and stores the update data in the storage unit 22a, thereby downloading the software (Q6). Then, the update processing unit 28 executes the software installation process. That is, the update processing unit 28 loads the update data of the storage unit 22a into the ROM of the ECU18 and installs the software (Q7).

When the state of the switch 54 is switched from IG-ON (or READY) to IG-OFF and the shift position detected by the shift position sensor 56 is "P", the permission confirmation unit 30 performs the confirmation process of confirming with the user whether to permit the downtime. In this confirmation process, when the user permits the downtime (Q8), the update processing unit 28 executes the software activation process of activating the software of the ECU 18 (Q9). The downtime indicates a time period during which the power mode of the vehicle 12 cannot be set to the START mode or the READY mode and the vehicle 12 cannot start traveling while the software activation process is performed. Once the software activation process is complete, the power mode of the vehicle 12 can be set to the START or READY mode.

When the software activation process is completed and the state of the switch 54 is switched from IG-OFF to IG-ON (or READY), the update processing unit 28 executes the completion process (Q10). For example, the update processing unit 28 uploads a result log to the server device 14. The result log includes information on whether the software of the ECU 18 has been successfully updated, the time when the activation process has been completed, and the like. The update processing unit 28 also causes the display unit 44 of the IVI 34 to display a completion notification indicating that the software update has been completed.

When the information acquisition unit 62 of the server device 14 acquires the result log (P7), the software update ends.

### 3 Processing Performed from IG-OFF to IG-ON (READY)

### 3-1 First Process

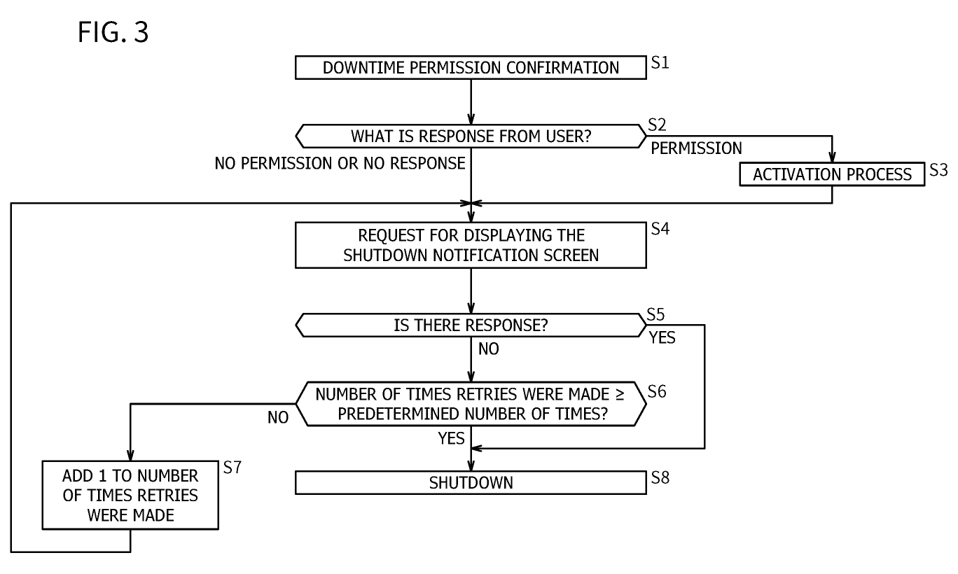

FIG. 3 is a flow chart of a first process performed by the software update device 18a during a period from IG-OFF to IG-ON (READY). FIG. 3 shows the details of the processes including the downtime permission (Q8) and the software activation process (Q9) shown in FIG. 2.

The software update device 18a performs the process of step S1 when it detects that the state of the switch 54 has been switched from IG-ON (or READY) to IG-OFF and that the shift position detected by the shift position sensor 56 is "P".

In step S1, the permission confirmation unit 30 performs the confirmation process of confirming with the user whether to permit the occurrence of the downtime. The process of step S1 corresponds to the process of Q8 shown in FIG. 2. For example, the permission confirmation unit 30 gives an instruction to the IVI 34 to display a permission confirmation screen. The permission confirmation unit 30 also measures the waiting time spent waiting for a response from the user. The permission confirmation unit 30 starts the confirmation process and starts measuring the waiting time with the timer.

In step S2, the permission confirmation unit 30 determines the result of a response from the user. For example, the permission confirmation unit 30 acquires from the IVI 34 the result of the response from the user. If the permission confirmation unit 30 obtains a response indicating that the user has permitted the downtime (step S2: permitted), the process proceeds to step S3. On the other hand, if the permission confirmation unit 30 acquires a response indicating that the user does not permit the downtime (step S2: not permitted), the process proceeds to step S4.

Incidentally, there is a case where the confirmation process regarding the downtime does not end within a predetermined time (referred to as a first predetermined time). For example, there is a case where the waiting time reaches the first predetermined time without a response from the user to the confirmation process. In such a case, the permission confirmation unit 30 determines that the timeout has occurred. If the permission confirmation unit 30 determines that the waiting time becomes equal to or longer than the first predetermined time stored beforehand in the storage unit 22a (step S2: no response), the process proceeds to step S4.

When the process proceeds from step S2 to step S3, the update processing unit 28 performs the activation process. The process of step S3 corresponds to the process of Q9 shown in FIG. 2. When the activation process ends, the process proceeds to step S4.

When the process proceeds from step S2 or step S3 to step S4, the update processing unit 28 issues a request for displaying a shutdown notification screen to the IVI 34. For example, the update processing unit 28 transmits to the IVI 34 a request signal indicating a request for displaying the shutdown notification screen. The shutdown notification screen is a screen for notifying the user that the software update device 18a will be shut down before the software update device 18a is shut down. The shutdown notification screen is displayed on the IVI 34.

When a shutdown notification request has been acquired normally, the display control unit 40 provided in the IVI 34 responds to the software update device 18a. For example, the display control unit 40 returns to the software update device 18a a signal (ACKknowledgement, hereinafter, “ACK”) indicating that the request signal has been received normally. However, there is a case where the display control unit 40 cannot respond to the software update device 18a as follows.

When the state of the switch 54 is in the IG-ON or READY state, a failure may occur in the process performed by the computing unit 36 of the IVI 34. In this case, the reset control unit 42 performs reset control (initialization) of the IVI 34. If the IVI 34 performs reset control after the software download process was performed and before the activation process is performed, the IVI 34 and the software update device 18a are not synchronized with each other. After reset control, the IVI 34 transitions to a sleep state after a substantially constant time has elapsed from the time when the state of the switch 54 was switched from IG-ON (or READY) to IG-OFF. This constant time is referred to as a sleep transition time. The software update device 18a cannot communicate with the IVI 34 that has transitioned to the sleep state. The request signal of the shutdown notification from the software update device 18a to the IVI 34 is transmitted after the sleep transition time or longer has elapsed from the time when the state of the switch 54 was switched from IG-ON (or READY) to IG-OFF. That is, when the reset control of the IVI 34 is performed, the IVI 34 cannot receive the request signal of the shutdown notification transmitted from the software update device 18a. Therefore, the display control unit 40 provided in the IVI 34 cannot return the ACK to the software update device 18a.

When the process proceeds from step S4 to step S5, the update processing unit 28 determines whether there is a response (ACK) to the request for displaying the shutdown notification screen from the display control unit 40 of the IVI 34. The update processing unit 28, after making a request for displaying the shutdown notification screen to the IVI 34 in step S4, waits for a response from the IVI 34 for a predetermined time (referred to as a second predetermined time) stored beforehand in the storage unit 22a. If there is a response from the IVI 34 within the second predetermined time (step S5: YES), the process proceeds to step S8. In this case, the display control unit 40 provided in the IVI 34 causes the display unit 44 to display the shutdown notification screen. On the other hand, if there is no response from the IVI 34 within the second predetermined time (step S5: NO), the process proceeds to step S6.

When the process proceeds from step S5 to step S6, the update processing unit 28 compares the number of times the request to display the shutdown notification screen has been retried with a predetermined number of times that is stored beforehand in the storage unit 22a. In the present embodiment, the number of retries is, for example, one, but is not limited to this. In this way, the update processing unit 28 limits the number of retries to a predetermined number. If the number of retries is less than the predetermined number of times (step S6: NO), the process proceeds to step S7. On the other hand, if the number of retries is equal to or greater than the predetermined number (step S6: YES), the process proceeds to step S8.

When the process proceeds from step S6 to step S7, the update processing unit 28 adds 1 to the number of retries. Thereafter, the process returns to step S4. In step S4, the update processing unit 28 retries the request for displaying the shutdown notification screen.

When the process proceeds from step S5 or step S6 to step S8, the update processing unit 28 executes shutdown of the software update device 18a. With the above, the series of processing shown in FIG. 3 ends. The update processing unit 28 commands the MID 46 to turn off when the software update device 18a is shut down. This causes the MID 46 to turn off.

After the shutdown of the software update device 18a, the user gets in the vehicle 12 and operates the switch 54. At this time, the state of the switch 54 is switched from IG-OFF to IG-ON (or READY). At this stage, the update processing unit 28 executes the completion process shown in FIG. 2.

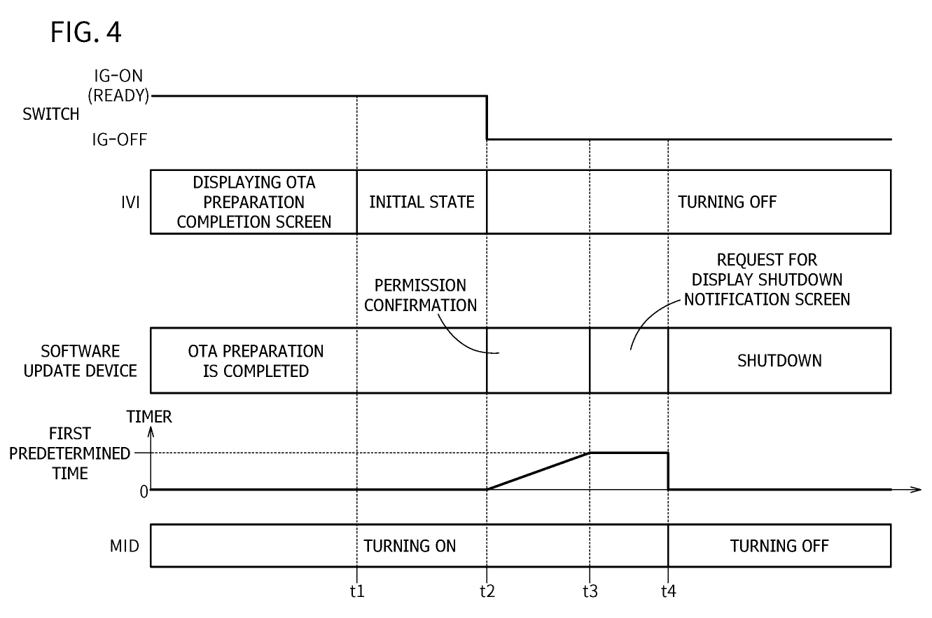

FIG. 4 is a time chart showing the states of the switch 54, the IVI 34, the software update device 18a, the timer, and the MID46. FIG. 4 shows the states of the switch 54, the IVI 34, the software update device 18a, the timer, and the MID 46 in the embodiment in which the reset control unit 42 executes the reset control of the IVI 34.

At time t1, the reset control unit 42 provided in the IVI 34 executes the reset control of the IVI 34. As a result, the IVI 34 returns to an initial state.

At time t2, the user operates the switch 54. At this time, the state of the switch 54 is switched from IG-ON (or READY) to IG-OFF. At this point, the permission confirmation unit 30 provided in the software update device 18a starts the confirmation process and starts measuring the waiting time with the timer (step S1 in FIG. 3).

At time t3, the waiting time measured by the timer reaches the first predetermined time (step S2 in FIG. 3: no response). Then, the update processing unit 28 issues a request for displaying the shutdown notification screen to the IVI 34 (step S4 in FIG. 3).

At time t4, the number of retries of the request for displaying the shutdown notification screen made by the update processing unit 28 is equal to or greater than a predetermined number of times (step S6 in FIG. 3: YES). At this time, the update processing unit 28 executes shutdown of the software update device 18a.

In the first process, the number of retries of the request for displaying the shutdown notification screen is limited to, for example, one. Thus, even if there is no response from the IVI 34 to the display request of the software update device 18a, it is possible to shut down the software update device 18a without repeating the retries of the display request endlessly. In addition, the MID 46 can also be turned off together with the shutdown of the software update device 18a. Therefore, according to the first process, it is possible to suppress a significant decrease in the remaining capacity of the battery provided in the vehicle 12 due to the MID 46 remaining turning on. In this way, according to the first process, the software can be updated favorably.

### 3-2 Second Process

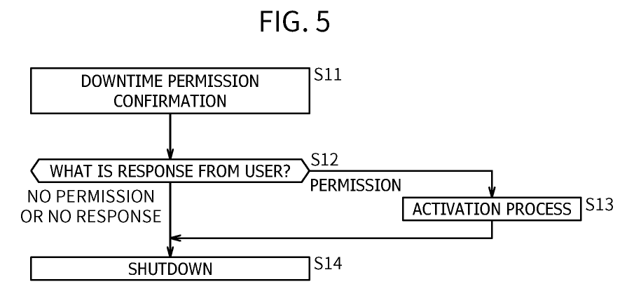

FIG. 5 is a flow chart of a second process performed by the software update device 18a during a period from IG-OFF to IG-ON (READY). The software update device 18a may perform the second process shown in FIG. 5 instead of the first process shown in FIG. 3.

The process of step S11 shown in FIG. 5 corresponds to the process of step S1 shown in FIG. 3. The process of step S12 shown in FIG. 5 corresponds to the process of step S2 shown in FIG. 3. The process of step S13 shown in FIG. 5 corresponds to the process of step S3 shown in FIG. 3. The process of step S14 shown in FIG. 5 corresponds to the process of step S8 shown in FIG. 3.

In the second process, no request for displaying the shutdown notification screen is made. Thus, even if there is no response from the IVI 34 to the display request of the software update device 18a, it is possible to shut down the software update device 18a without repeating the retries of the display request endlessly. In addition, the MID 46 can also be turned off together with the shutdown of the software update device 18a. Therefore, according to the second process, it is possible to suppress a significant decrease in the remaining capacity of the battery provided in the vehicle 12 due to the MID 46 remaining turned on. In this way, according to the second process, the software can be updated favorably.

With respect to the above embodiments, the following supplementary notes are further disclosed.

### Supplementary note 1

A software update system (10) of the present disclosure includes a vehicle (12), a server device (14) configured to communicate with the vehicle via a network (16), a permission confirmation unit (30) configured to execute a confirmation process to confirm with a user whether to permit execution of a software update process for an electronic control unit (18) provided in the vehicle, and an update processing unit (28) configured to execute the software update process in a case where the execution of the software update process is permitted by the user, wherein in a case where the confirmation process is not completed within a predetermined time, the update processing unit does not execute the software update process and executes a shutdown after causing a display control unit (40) to execute the display of a shutdown notification screen, and in a case where a response from the display control unit to a request for the display of the shutdown notification screen is not acquired, the update processing unit executes the shutdown after repeating retries a predetermined number of times.

According to the above configuration, the electronic control unit (software update device) equipped with the update processing unit can be shut down without repeating the retries of the display request endlessly. In addition, the display device connected to the electronic control unit can also be turned off in accordance with the shutdown of the electronic control unit. Therefore, according to the above configuration, it is possible to suppress a significant decrease in the remaining capacity of the battery provided in the vehicle caused by the display device remaining turned on. Thus, according to the above configuration, the software can be updated preferably.

### Supplementary note 2

A software update system of the present disclosure includes a vehicle, a server device configured to communicate with the vehicle via a network, a permission confirmation unit configured to execute a confirmation process to confirm with a user whether to permit execution of a software update process for an electronic control unit provided in the vehicle, and an update processing unit configured to execute the software update process in a case where the execution of the software update process is permitted by the user, wherein in a case where the confirmation process is not completed within a predetermined time, the update processing unit does not execute the software update process and executes a shutdown without causing a display control unit to execute display of a shutdown notification screen.

According to the above configuration, the electronic control unit (software update device) equipped with the update processing unit can be shut down without repeating the retries of the display request endlessly. In addition, the display device connected to the electronic control unit can also be turned off in accordance with the shutdown of the electronic control unit. Therefore, according to the above configuration, it is possible to suppress a significant decrease in the remaining capacity of the battery provided in the vehicle caused by the display device remaining turned on. Thus, according to the above configuration, the software can be updated preferably.

### Supplementary note 3

In the software update system described in supplementary note 1, the predetermined number of times may be one.

### Supplementary note 4

In the software update system according to supplementary note 1 or 2, the electronic control unit including the update processing unit may be shut down in the shutdown.

### Supplementary note 5

A software update device of the present disclosure is a software update device in the software update system described in supplementary note 1 or 2, including the permission confirmation unit and the update processing unit.

### Supplementary note 6

A software update method of the present disclosure is a software update method in which date communication is performed between a vehicle and a server device via a network, a permission confirmation step of executing a confirmation process to confirm with a user whether to permit execution of a software update process for an electronic control unit provided in the vehicle, and an update processing step of executing the software update process in a case where the execution of the software update process is permitted by the user, wherein in a case where the confirmation process is not completed within a predetermined time, in the update processing step, the software update process is not executed and a shutdown is executed after a display control unit is caused to execute the display of a shutdown notification screen, and in a case where a response from the display control unit to a request for the display of the shutdown notification screen is not acquired, in the update processing step, the shutdown is executed after retries are repeated a predetermined number of times.

### Supplementary note 7

A program of the present disclosure causes a computer to execute the software update method described in supplementary note 6.

Although the present disclosure has been detailed, the present disclosure is not limited to the individual embodiments described above. These embodiments may be variously added, replaced, altered, partially deleted, etc., without departing from the scope of the present disclosure or the intent of the present disclosure as derived from the claims and their equivalents. These embodiments can also be implemented in combination. For example, in the above-described embodiment, the order of the operations and the order of the processes are shown as an example, and are not limited to these. The same applies to the case where numerical values or mathematical expressions are used in the description of the above-described embodiment.

1. A software update system comprising:
a vehicle;
a server device configured to communicate with the vehicle via a network; and
one or more processors that execute computer-executable instructions stored in a memory,
wherein the one or more processors execute the computer-executable instructions to cause the software update system to:
perform a confirmation process of confirming with a user whether to permit execution of a software update process for an electronic control unit provided in the vehicle;
execute the software update process in a case where the execution of the software update process is permitted by the user;
in a case where the confirmation process is not completed within a predetermined time, execute, not executing the software update process, a shutdown after causing a processor of the one or more processors in charge of display control for displaying a shutdown notification screen to execute the display of the shutdown notification screen; and
in a case where a response to a request for displaying the shutdown notification screen is not acquired from the processor in charge of the display control, execute the shutdown after repeating retries a predetermined number of times.

2. A software update system comprising:
a vehicle;
a server device configured to communicate with the vehicle via a network; and
one or more processors that execute computer-executable instructions stored in a memory,
wherein the one or more processors execute the computer-executable instructions to cause the software update system to:
perform a confirmation process of confirming with a user whether to permit execution of a software update process for an electronic control unit provided in the vehicle;
execute the software update process in a case where the execution of the software update process is permitted by the user;
in a case where the confirmation process is not completed within a predetermined time, execute, not executing the software update process, a shutdown without causing a processor of the one or more processors in charge of display control for displaying a shutdown notification screen to execute the display of the shutdown notification screen.

3. The software update system according to claim 1, whereinthe predetermined number of times is one.

4. The software update system according to claim 1, wherein
the one or more processors include the electronic control unit, and
in the shutdown, the electronic control unit that executes the software update process is shut down.

5. A software update device in the software update system according to claim 1, comprising the one or more processors.

6. A software update method executed by one or more processors,wherein data communication is performed between a server device and a vehicle through a network, the software update method comprising:
performing a confirmation process of confirming with a user whether to permit execution of a software update process for an electronic control unit provided in the vehicle; and
executing the software update process in a case where the execution of the software update process is permitted by the user,
wherein
in the executing of the software update process, in a case where the confirmation process is not completed within a predetermined time, the software update process is not executed and a shutdown is executed after a processor of the one or more processors in charge of display control for displaying a shutdown notification screen is caused to displaythe shutdown notification screen and
in a case where a response to a request for displaying the shutdown notification screen is not acquired from the processor in charge of the display control, in the executing of the software update process, the shutdown is executed after retries are repeated a predetermined number of times.

7. A non-transitory storage medium storing a program for causing a computer to execute the software update method according to claim 6.

8. The software update system according to claim 2, whereinthe one or more processors include the electronic control unit, and
in the shutdown, the electronic control unit that executes the software update process is shut down.

9. A software update device in the software update system according to claim 2, comprisingthe one or more processors.
